(19) United States
(12) Patent Application Publication
(10) Pub. No.: US 2002/0196743 A1
(43) Pub. Date: Dec. 26, 2002

(54) Apparatus and method for enhancing performance in a packet data system

(76) Inventors: Sebastian Thalanany, Buffalo Grove, IL (US); Ajoy Singh, Palatine, IL (US)

Correspondence Address: MOTOROLA, INC., 1303 EAST ALGONQUIN ROAD, IL01/3RD, SCHAUMBURG, IL, 60196

(21) Appl. No.: 10/158,722

(22) Filed: May 30, 2002

Related U.S. Application Data
(60) Provisional application No. 60/299,704, filed on Jun. 20, 2001.

(51) Int. Cl. H04J 1/16

(52) U.S. Cl. 370/252; 370/392

(57) ABSTRACT

An apparatus and method for controlling loss of data packets in a system, wherein the packets are transmitted from a source to a destination via a packet forwarder over a plurality of links having different bandwidths. The packet forwarder actively monitors the average number of packets in the first buffer and when the average number rises above a pre-defined threshold, the packet forwarder signals the source to stop sending data packets. The source will then compress and store packets it receives from a network in a second buffer until the source can again transmit the compressed packets to the packet forwarder. When the source's buffer becomes full, it will discard any packets it receives from the network before performing compression. When the average number of packets in the first buffer drops below the threshold, the packet forwarder signals the source to resume sending compressed packets for transfer to the destination.

### FIELD OF THE INVENTION

The invention relates to the field of communication systems, and more particularly, to a Code Division Multiple Access (CDMA) communications system.

### BACKGROUND OF THE INVENTION

In the existing 3^{rd} Generation Partnership Project 2 (3GPP2) architecture, the Access Provider Network (APN) contains a CDMA IS-2000 based Radio Access Network (RAN), and other network elements including a Packet Data Serving Node (PDSN). The PDSN in the APN is coupled to a Packet Control Function (PCF) in the RAN via a routed network. The logical interface between the PDSN and the PCF is referred to as the RAN-PDSN (RP) interface. The RP interface is also referred to as the A10-A11 interface or the Aquater interface. A Mobile Station (MS) in communication with the RAN and the PDSN use Point-to-Point Protocol (PPP) as the access protocol. The PPP frames are tunneled to the PDSN via the RAN.

PPP supports mechanisms for functions such as header compression, payload compression and encryption. PPP frames are terminated at the MS and the PDSN. PPP frames are transmitted between the PCF and the PDSN over the RP interface using the Generic Routing Encapsulation (GRE) protocol. PPP frames are transmitted between the RAN and the MS over the air-interface.

The RAN interfaces with the MS over a low bandwidth wireless link, which is subject to signal fading. The RAN interfaces with a PDSN over a relatively high bandwidth stable wired link. The difference in bandwidth is likely to cause packet loss between the PDSN and MS because the PDSN can transfer packets to the RAN at a higher rate than the RAN can transfer packets to the MS. The loss of a single GRE packet, transferred from the PDSN to the PCF, could translate into a loss of multiple PPP frames at the MS. In the case of compressed packets, GRE packet losses can result in a larger effective loss of packets destined for the MS. For example, when delta compression algorithms are used to compress packet headers, or when Lempel, Ziv and Welch (LZW) based payload compression is employed, the impact of GRE packet losses for packets destined for the MS is magnified. Further, a compressed packet that arrives at the MS subsequent to a GRE packet loss in the RAN would not be correctly decompressed at the MS unless the compression state is renegotiated between the MS and the PDSN. The loss of multiple packets in this manner adversely impacts both the application running at the MS as well as the efficient use of the limited bandwidth wireless link. The larger effective loss of packets destined for the MS may also occur in the case of non-compressed packets when byte streams containing frame boundaries are lost at the PCF or some intermediate node between the PCF and the MS.

Thus, there is a need for an apparatus and method for controlling the loss of packets in a system wherein the packets are transmitted from a source to a destination over a plurality of links having different bandwidths.

### BRIEF DESCRIPTION OF THE DRAWINGS

FIG. 1 is a block diagram showing the relationship among network components in support of the apparatus and method for controlling the loss of packets in accordance with the present invention.

FIG. 2 is a flow chart of the logic flow in the PCF for the preferred embodiment of controlling the loss of packets in accordance with the present invention.

FIG. 3 is a flow chart of the logic flow in the PDSN for ceasing to transmit packets to the PCF in accordance with the preferred embodiment of the present invention.

FIG. 4 is a flow chart of the logic flow in the PDSN for transmitting packets to the PCF in accordance with the preferred embodiment of the present invention.

### DESCRIPTION OF THE PREFERRED EMBODIMENTS

The present invention is an apparatus and method for controlling the loss of packets in a system, wherein data packets are transmitted from a source to a destination via a plurality of links having different bandwidth. In the preferred embodiment, the invention is implemented in the cdma2000 system defined in the “Inter-Operability Specification (IOS) for CDMA 2000 Access Network Interfaces”, TIA/EIA/IS-2001-A, Ballot Version December 2000 (hereinafter referred to as “IOS”). However, in alternate embodiments, the invention can be implemented in a time division multiple access (TDMA) system, frequency division multiple access (FDMA) or OFDM system.

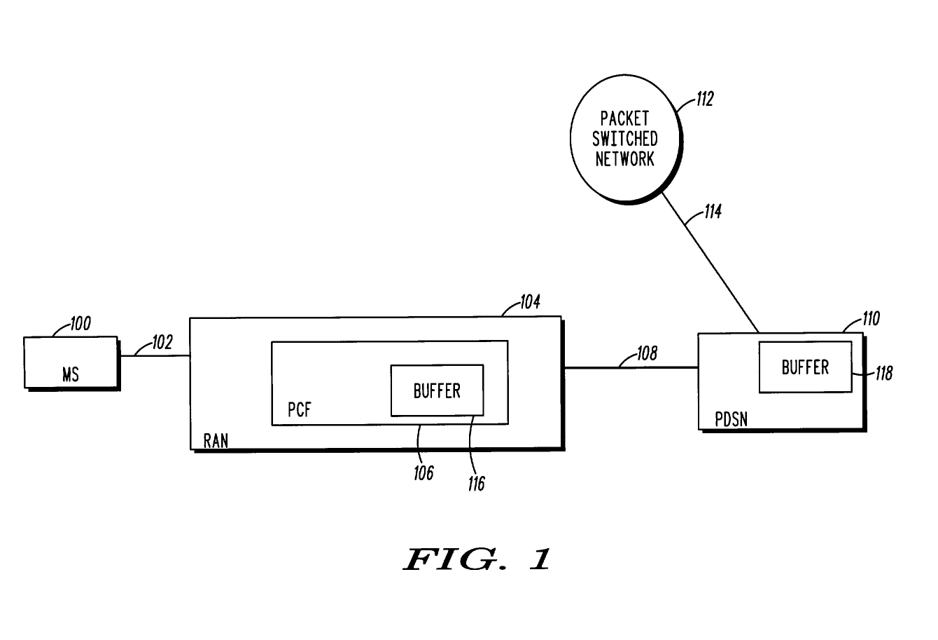

FIG. 1 is a block diagram showing, in pertinent part, the architecture of the 3GPP2 cdma2000 system 100 in which the preferred embodiment of the present invention can be implemented. The system includes a source, preferably a PDSN 110 which is coupled to a Packet Switched Network (PSN) 112 for receiving internet protocol (IP) packets over an Ethernet or Wide Area Network (WAN) interface 114. The PDSN 110 preferably transforms the packets into PPP frames encapsulated in GRE packets and transmits them to a packet forwarder (any device that forwards packets from one place to another) over the relatively high bandwidth RP interface 108.

In the preferred embodiment, the packet forwarder is a PCF 106, in a RAN 104. It will be recognized by one of ordinary skill in the art that the RAN 104 may contain other devices not shown in FIG. 1. The PCF 106 maintains a buffer 116 for temporarily storing the packets for subsequent transmission to a destination, preferably a MS 100, over a lower bandwidth RF link 102. The PCF stores packets received from the PDSN 110 in the buffer 116 when the RAN 104 is unable to schedule radio resources for the transmission of the packets to the MS 100. If the PCF buffer 116 becomes full and the RAN 104 is still unable to schedule radio resources for the transmission of the packets, packets will be lost. The PCF 106 also stores data packets received from the PDSN 110 because the PCF 106 cannot transmit the packets to the MS 100 as fast as it receives the packets from the PDSN 110. A PDSN 110 and PCF 106 (in a RAN 104) that can be used with the present invention are described in greater detail in Section 2.14 of the IOS. It will be recognized by one of ordinary skill in the art that any network for transmitting data packets to a PDSN and any MS for receiving data packets from the PCF may be used with the present invention.

In the preferred embodiment, the apparatus and method of the present invention employs a control scheme to enhance the performance of packet data transfer from the PDSN 110 to the MS 100, when a congestion event is detected in the RAN 104. Congestion events can include, but are not limited to wireless link degradation, system overload and signaling (i.e., signaling messages unable to be exchanged in a timely manner). The preferred embodiment of the present invention enhances the performance of the associated application. Additionally, the preferred embodiment improves the utilization of the relatively low bandwidth wireless link by minimizing the transfer of compressed frames over the air interface that will be incorrectly decompressed at the MS 100.

The PCF 106 actively monitors the status of the buffer 116 associated with a packet data session. A packet data session is defined as a shared state between the MS 100 and the PSN 112. The status of the buffer 116 indicates whether the average number of packets in the buffer 116, is above or below a pre-defined threshold. If the status indicates that the average number of packets has exceeded the threshold, a potential congestion event has occurred and the PCF 106 instructs the PDSN 110 to stop transferring packets to the PCF 106. (This action is taken to decrease the occurrence of the PCF 106 dropping packets). The PDSN 110 also maintains a buffer 118 for storing packets received from the PSN 112. In the preferred embodiment, if the PDSN buffer 118 is not full, the PDSN 110 will compress the packets received from the PSN 112 and store the compressed packets in the buffer 118. However, if the PDSN buffer 118 is full, the PDSN 106 will drop the packets received from the PSN 112 before performing compression. When the PCF 106 detects that the average number of packets in the buffer has fallen below the threshold, the PCF 106 instructs the PDSN 110 to resume transferring packets.

Despite the actions described above, the PCF 106 may drop a compressed packet or detect a packet drop at other RAN 104 devices due to link layer aborts. When the drop occurs, the PCF 106 sends a Compression Control Protocol (CCP) reset request message or header compression CONTEXT-STATE message (depending on the type of compression implemented) to the PDSN 110. These messages initiate the CCP or header compression resynchronization procedure at the PDSN 110. In an alternate embodiment, an out-of-band control signal may be sent from the PCF 106 to the PDSN 110 to initiate compression state resynchronization. In this case, the PDSN 110 will receive the out-of band signal from the PCF 106 and initiate the compression resynchronization procedure. The procedures for header and payload compression re-synchronization are defined in the following documents: (1) Network Working Group; Request for Comments: 2507; M. Degermark et al, Lulea University of Technology, February 1999, (2) Network Working Group; Request for Comments: 2508; S. Casner et al., Cisco Systems, February 1999, (3) Network Working Group, Request for Comments: 1962; D Rand; Novell; June 1996, (4) Network Working Group; Request for Comments: 1144; V. Jacobson; LBL; February 1990, and (5) Network Working Group; Request for Comments: 3095 which is based on draft-ietf-rohc-rtp-09.txt (by Carsten Burmeister; Feb. 26, 2001). The resynchronization procedure resets state information associated with compression at both the PDSN 110 and the MS 100. Prior to the completion of CCP resynchronization, all the PPP frames received by the MS 100 are rejected because the state information associated with compression is not yet initialized.

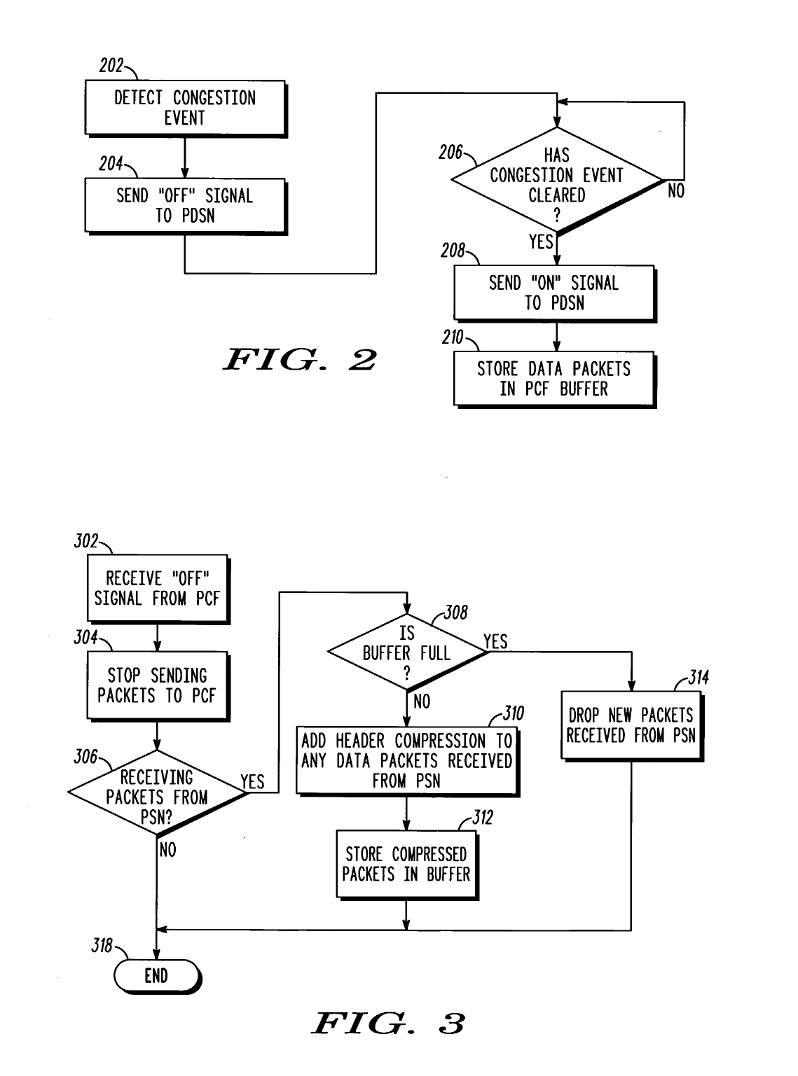

Referring to the flow diagrams of FIGS. 2-4, details of the preferred embodiment of the method of the present invention are described. In FIG. 2, at step 202, the method detects a congestion event in the PCF 106 and sends an “off” signal to the PDSN 110 to instruct the PDSN 110 to stop sending data packets (step 204). In the preferred embodiment, the congestion event is a full PCF buffer. When the PCF 106 detects that the congestion event has cleared (step 206), it sends an “on” signal to the PDSN 110 to instruct the PDSN 110 to resume sending data packets (step 208). At step 210, the PCF 106 stores the data packets received from the PDSN 110 in the PCF buffer 116 for subsequent transmission to the MS 100.

The flow chart of FIG. 3 details the preferred method at the PDSN 110 when it receives the “off” signal from the PCF 106 (step 302). At step 304, the PDSN 110 stops sending packets to the PCF 106. At step 306, the PDSN 204 determines whether it is currently receiving packets from the PSN 112. If the PDSN 110 is not receiving packets from the PSN 112, the method ends at step 318. If the PDSN 110 is receiving packets, it will determine whether its buffer 118 is full (step 308). In the preferred embodiment, if the PDSN buffer 118 is not full, the PDSN 110 compresses the received packets (step 310), stores the compressed packets in its buffer 118 (step 312), and the method ends (step 318). If the PDSN buffer 118 is full, the PDSN 110 drops the packets received from the PSN 112 (step 314) and the method ends (step 318).

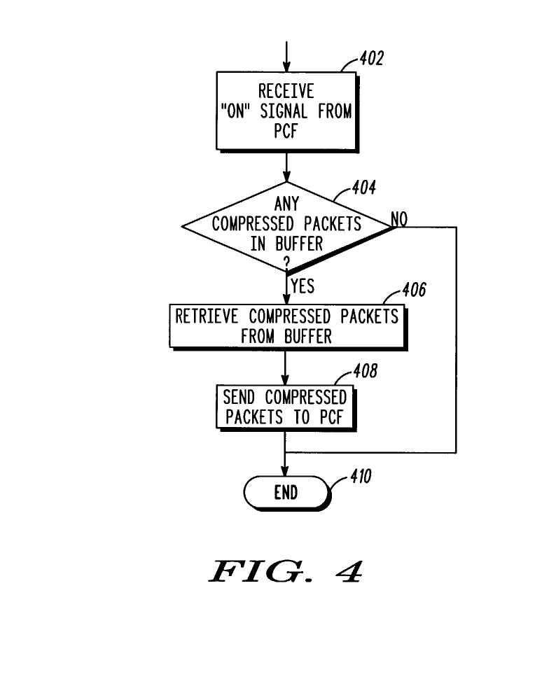

The flow chart of FIG. 4 details the preferred method at the PDSN 110 when it receives the “on” signal from the PCF 106 (step 402). At step 404, the method determines whether there are any compressed packets in the PDSN buffer 118. If there are no stored packets, the method ends at step 410. If there are compressed packets, the method retrieves the compressed packets from the buffer 118 (step 406), sends the compressed packets to the PCF 106 (step 408), and the method ends (step 410).

The apparatus and method of the present invention enhances the performance of a packet data session, for packets destined for the MS 100. The method provides an extension to known signaling messages between the PDSN 110 and PCF 106. Additionally, the present invention provides an enhancement of the utilization of radio resources by eliminating the transmission over the air interface 102 of compressed packets that will be incorrectly decompressed at the MS 100. The PDSN 110 uses the “off” signal received from the PCF 106 to buffer or drop packets that are destined for the MS 100. Because the packets are dropped at the PDSN 110 before they are compressed, the loss of multiple PPP frames at the MS 100 is avoided, thus increasing performance.

In the preferred embodiment of the present invention, the PCF 106 sends a CCP reset request message and/or a header compression CONTEXT-STATE message to the PDSN to initiate the CCP re-synchronization procedure, and header compression re-synchronization procedure, respectively, when a packet containing compressed PPP frames is dropped at the PCF 106. These messages are also sent if the PCF 106 receives loss indication from other RAN devices. The packet loss may occur due to buffer overflow or link layer abort. In an alternate embodiment, the PCF 106 may send an out-of-band control signal to the PDSN 110 to initiate compression state re-synchronization.

In the absence of the method of the present invention, a dropped packet containing compressed PPP frame(s) at the PCF 106 or any other intermediate node between the PCF 106 and the MS 100 is likely to result in missing PPP frames at the MS 100. The MS 100 detects missing PPP frames after it receives subsequent PPP frames from the PDSN 110. The detection of a PPP frame loss at the MS 100, and the MS 100 initiating the CCP and header compression re-synchronization procedures incurs a higher latency, and consumes radio resources.

Those skilled in the art will recognize that various modifications and variations can be made in the apparatus of the present invention and in construction of this apparatus without departing from the scope or spirit of this invention. For example, in the method, the PDSN may store the packets received from the PSN 112 and compress the packets before sending them to the PCF 106. Also, the PDSN 110 may encrypt the packets received from the PSN 112 instead of or in addition to compressing them for transmission to the MS 100.

What is claimed is:

1. In a communication system having a source that communicates with a packet forwarder over a first link and a destination that communicates with the packet forwarder over a second link having a bandwidth lower than a bandwidth of the first link, the packet forwarder monitoring a first buffer that stores data packets sent from the source for transmission to the destination, a method of controlling the loss of data packets comprising the steps of:
determining an amount of data packets stored in the first buffer; and
if the amount is above a first threshold, sending a signal to the source to stop transmitting packets.

2. The method of claim 1 wherein the data packets are compressed by the source before transmission.

3. The method of claim 2 wherein the communication system further comprises a network that transmits uncompressed data packets to the source, wherein the source maintains a second buffer for storing the compressed data packets and wherein the method further comprises the steps of:
halting transmission of compressed data packets;
determining whether a number of compressed data packets in the second buffer is above a second threshold; and
if the number is above the second threshold, discarding the uncompressed data packets received from the network.

4. The method of claim 3 further comprising the steps of:
if the number is below the second threshold, compressing the uncompressed data packets received from the network; and
storing the compressed data packets in the second buffer.

5. The method of claim 2 wherein the communication system further comprises a network that transmits uncompressed data packets to the source, wherein the source maintains a second buffer for storing the uncompressed data packets and wherein the method further comprises the steps of:
halting transmission of compressed data packets;
determining whether a number of uncompressed data packets in the second buffer is above a second threshold; and
if the number is above the second threshold, discarding the uncompressed data packets received from the network.

6. The method of claim 5 further comprising the step of if the number is below the second threshold, storing the uncompressed data packets in the second buffer.

7. The method of claim 1 further comprising the step of signaling the source to start sending packets to the packet forwarder when the amount of data packets in the first buffer is below the first threshold.

8. The method of claim 1 further comprising the steps of:
detecting a packet loss at the packet forwarder; and
sending a message to the source to initiate a resynchronization of a compression state.

9. In a communications system comprising a Packet Data Serving Node (PDSN) for transmitting compressed data packets to a Packet Control Function (PCF) over a link having a first bandwidth and a MS for receiving the compressed data packets from the PCF over link having a second bandwidth lower than the first bandwidth, wherein the PCF monitors a first buffer that stores the compressed data packets, a method of controlling the loss of compressed data packets by the PCF comprising the steps of:
determining an amount of compressed data packets stored in the first buffer; and
if the amount is above a first threshold, instructing the PDSN to stop sending compressed packets to the PCF.

10. The method of claim 9 wherein the PDSN receives uncompressed data packets from a Packet Switched Network (PSN) and wherein the PDSN monitors a second buffer, the method further comprising the steps of:
halting transmission of compressed data packets to PCF;
determining whether a number of compressed data packets in the second buffer is above a second threshold; and
if the number is above the second threshold, discarding the uncompressed data packets received from the PSN.

11. The method of claim 10 further comprising the steps of:
if the number is below the second threshold, compressing the uncompressed data packets received from the PSN; and
storing the compressed data packets in the second buffer.

12. The method of claim 9 further comprising the step of signaling the PDSN to start sending packets to the PCF when the amount of compressed packets in the first buffer is below the first threshold.

13. An apparatus for reducing the loss of data packets in a communication system comprising:
a network;
a source operatively coupled to the network for receiving uncompressed data packets;
a packet forwarder operatively coupled to the source for receiving compressed data packets over a first communication link having a first bandwidth;
a first buffer coupled to the packet forwarder for storing compressed data packets received from the source;
a destination for receiving the compressed data packets over a second communication link having a second bandwidth lower than the first bandwidth; and
wherein the packet forwarder instructs the source to stop sending compressed data packets when the packet forwarder detects that an amount of compressed data packets stored in the first buffer is above a threshold.

14. The apparatus of claim 13 wherein the source compresses the uncompressed data packets received from the network before storing the compressed data packets in the second buffer.
